(19) United States
(12) Patent Application Publication
(10) Pub. No.: US 2017/0147768 A1
(43) Pub. Date: May 25, 2017

(54) SYSTEM AND METHOD FOR DETECTING AND MONITORING ACUTE MYOCARDIAL INFARCTION RISK

(71) Applicants: Liwei Ma, Issaquah, WA (US); Charles Wang Ma, Issaquah, WA (US); Young Young Ma, Issaquah, WA (US)

(72) Inventors: Liwei Ma, Issaquah, WA (US); Charles Wang Ma, Issaquah, WA (US); Young Young Ma, Issaquah, WA (US)

(21) Appl. No.: 15/425,328

(22) Filed: Feb. 6, 2017

(51) Int. Cl. G06F 19/00

(52) U.S. Cl. CPC G06F 19/345; G06F 19/363; G06F 19/3418; G06F 19/3487

(57) ABSTRACT

Disclosed are a method and a system using user personal, CBC, CMP and Lipid Panel data to detect a user acute myocardial infarction (AMI) risk and help user monitor AMI risk. Most AMI risk screening and diagnosis are related with the markers, video, image data, etc. although past researches have shown that serum albumin, RBC, MCV, MPV and PDW are all significantly correlated with AMI risk, use of the blood test results of CBC, CMP and Lipid Panel data to detect and monitor AMI risk has never been reported. Traditionally, AMI risk detecting and monitoring have been managed by doctors and hospitals and a user is unable to do it by himself or herself. The purpose of this invention is to provide an intelligent AMI risk detecting and monitoring system enabling users to detect and monitor AMI risk.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

Acute myocardial infarction (AMI) remains a leading cause of morbidity and mortality worldwide. The estimated annual incidence of myocardial infarction (MI) in US is 525,000 new attacks and 210,000 recurrent attacks in 2015. The estimated direct and indirect cost of myocardial infarction (MI) in 2010 was $11.5 billion [1]. Early detecting and monitoring acute myocardial infarction (AMI) risk would help reduce the incidence of acute myocardial infarction (AMI) and save millions of lives worldwide.

Acute myocardial infarction (AMI) is the medical name for a heart attack. A heart attack is a life-threatening condition that occurs when blood flow to the heart is abruptly cut off, causing tissue damage. This is usually the result of a blockage in one or more of the coronary arteries. A blockage can develop due to a buildup of plaque, a substance mostly made of fat, cholesterol, and cellular waste products [2].

Most acute myocardial infarction (AMI) screening and diagnosis are related with the biomarkers, physiological parameters, physiological fluid, gene, etc. for example, patents of “Detection of acute myocardial infarction biomarkers” by Shebuski, et al. [20050250156], “Virtual Physician Acute Myocardial Infarction Detection System and Method” by Lee, et al. [8712509], “System and assay for detection of cardiac markers for assessing acute myocardial infarction” by Haik, Y. [7998755], “Method for Detecting the Risk of Cardiovascular Diseases Such as Acute Myocardial Infarction and Coronary Heart Disease By Analysing Defesin” by Salonen, et al. [20070299025], “System and method for the detection of acute myocardial infarction” by Boute, et al. [8298153], “METHODS AND COMPOSITIONS FOR DIAGNOSIS OF ACUTE MYOCARDIAL INFARCTION (AMI)” by McDevitt, et al. [20120208715], and “METHODS FOR THE DETECTION AND MONITORING OF ACUTE MYOCARDIAL INFARCTION” by Liang, et al. [8841084].

Although past researches have shown that WBC count, Neutrophil/Lymphocytes Ratio, serum urea nitrogen level are all significantly correlated with acute myocardial infarction (AMI) [3, 4, 5, 6, 7], use of the blood test results of Complete Blood Count (CBC), Comprehensive Metabolic Panel (CMP) and Lipid Panel data to detect and monitor acute myocardial infarction (AMI) risk has never been reported.

### REFERENCES CITED

### U.S. Patent Documents

1. U.S. Pat. No. 8,712,509
2. U.S. Pat. No. 7,998,755
3. U.S. Pat. No. 8,298,153
4. U.S. Pat. No. 8,841,084
5. 20050250156
6. 20070299025
7. 20120208715

### OTHER REFERENCES

1. American Heart Associationo. Heart Disease and Stroke Statistics-2015 Update: Chapter 19, e227.
2. HealthLine. Acute Myocardial Infarction. http://www.healthline.com/health/acute-myocardial-infarction#Overvew1
3. Mary Grzybowski, Robert D. Welch, Lori Parsons, Chiadi E. Ndumele, Edmond Chen, Robert Zalenski, Hal V. Barron. The Association between White Blood Cell Count and Acute Myocardial Infarction In-hospital Mortality: Findings from the National Registry of Myocardial Infarction. Academic Emergency Medicine 2004; 11:1049-1060.
4. Ala Hussain Abbase [symbol] , Murad Abdul kadum Khadim. Leukocytes Count and Neutrophil/Lymphocytes Ratio in Predicting In-Hospital Outcome after Acute Myocardial Infarction. Medical Journal of Babylon. 2014, 7:4.
5. S. T. Normand, M. E. Glickman, R. G. Sharma, B. J. McNeil. Using admission characteristics to predict short-term mortality from myocardial infarction in elderly patients. Results from the Cooperative Cardiovascular Project. JAMA, 275 (1996), pp. 1322-1328.
6. Kazory A. Emergence of blood urea nitrogen as a biomarker of neurohormonal activation in heart failure. Am J Cardiol 2010; 106:694-700.
7. Lee D. S., Austin P. C., Rouleau J. L., et al. Predicting mortality among patients hospitalized for heart failure: derivation and validation of a clinical model. JAMA 2003; 290:2581-2587.

### BRIEF SUMMARY OF THE INVENTION

The present invention provides a method and a system using age, gender, height, weight, BMI, blood pressure and blood test results of Complete Blood Count (CBC), Comprehensive Metabolic Panel (CMP) and Lipid Panel data to detect and monitor acute myocardial infarction (AMI) risk.

In some embodiments, the method for provide a user acute myocardial infarction (AMI) risk detecting and monitoring system comprises steps of: (A) Collecting age, gender, height, weight, BMI, blood pressure and blood test results of Complete Blood Count (CBC), Comprehensive Metabolic Panel (CMP) and Lipid Panel data; (B) Processing, integrating and transforming the collected data; (C) Predicting the probabilities of acute myocardial infarction (AMI) risk; (D) Analyzing and evaluating the probabilities of acute myocardial infarction (AMI) risk; (E) Generating and delivering the acute myocardial infarction (AMI) risk analysis report including standardized risk score and risk evaluation results.

In other embodiments, the system for provide a user acute myocardial infarction (AMI) risk detecting and monitoring system comprises: one or more CPU processors, and RAM communicatively coupled to the one of more CPU processors for storing: (A) A data processing module that aggregates age, gender, height, weight, BMI, blood pressure and the blood test results of Complete Blood Count (CBC), Comprehensive Metabolic Panel (CMP) and Lipid Panel data at individual level and transforms the data; (B) An analysis and evaluation module that analyzes the calculated acute myocardial infarction (AMI) risk probabilities; (C) An acute myocardial infarction (AMI) risk detecting and monitoring platform that dynamical collects user age, gender, height, weight, BMI, blood pressure and blood test results of Complete Blood Count (CBC), Comprehensive Metabolic Panel (CMP) and Lipid Panel data and delivers the acute myocardial infarction (AMI) risk analysis report through the user interface to help user detect and monitor acute myocardial infarction (AMI) risk.

One object of the present invention is to provide a method comprising collecting user age, gender, height, weight, BMI, blood pressure and the blood test results of Complete Blood Count (CBC), Comprehensive Metabolic Panel (CMP) and Lipid Panel data, processing the collected data, using the data to predict acute myocardial infarction (AMI) risk, analyzing and evaluating the predicted acute myocardial infarction (AMI) risk, and generating and delivering the acute myocardial infarction (AMI) risk analysis report for a user to detect and monitor acute myocardial infarction (AMI) risk.

Another object of the present invention is to provide a system comprising data collecting, data processing, acute myocardial infarction (AMI) risk predicting, acute myocardial infarction (AMI) risk evaluating and acute myocardial infarction (AMI) risk analysis report generating for a user to detect and monitor acute myocardial infarction (AMI) risk.

The embodiments of the present invention are further described through below detailed examples and the drawings.

### BRIEF DESCRIPTION OF THE DRAWINGS

FIG. 1 is a diagram showing an example system including a user, a user device, one or more networks, and one or more cloud servers. In this system, acute myocardial infarction (AMI) risk analysis report may be provided to the users based on user age, gender, height, weight, BMI, blood pressure and the blood test results of Complete Blood Count (CBC), Comprehensive Metabolic Panel (CMP) and Lipid Panel data.

FIG. 2 is a diagram showing an example process of user accessing acute myocardial infarction (AMI) risk detecting and monitoring platform and providing age, gender, height, weight, BMI, blood pressure and the blood test results of Complete Blood Count (CBC), Comprehensive Metabolic Panel (CMP) and Lipid Panel data; Cloud database collects user data and transforms the data into different data files.

FIG. 3 is a diagram showing an example process of aggregating data, building predictive model, determining probabilities of acute myocardial infarction (AMI) risk, analyzing and evaluating probabilities of acute myocardial infarction (AMI) risk and generating acute myocardial infarction (AMI) risk analysis report by the cloud server.

FIG. 4 is a diagram showing a user interface used to display acute myocardial infarction (AMI) risk analysis report to a user based on user provided data, calculated probabilities of acute myocardial infarction (AMI) risk and evaluation results.

FIG. 5 is a diagram showing an example process of collecting user data, processing the collected data, predicting acute myocardial infarction (AMI) risk, analyzing and evaluating acute myocardial infarction (AMI) risk, delivering acute myocardial infarction (AMI) risk analysis report and updating the predictive model.

### DETAILED DESCRIPTION OF THE INVENTION

The description begins with a section, entitled “Example Environment”, describing a system for delivering acute myocardial infarction (AMI) risk analysis report to a user devices monitoring acute myocardial infarction (AMI) risk. Next, the description includes a section entitled “Data Collection”, describes a system for collecting user age, gender, height, weight, BMI, blood pressure and the blood test results of Complete Blood Count (CBC), Comprehensive Metabolic Panel (CMP) and Lipid Panel data. A “Prediction” section then follows, which describes using predictive model to calculate acute myocardial infarction (AMI) risk probabilities. Next, the description includes an “Analysis and Evaluation” section that describes the process to analyze and evaluate the probabilities. Then, the description includes a “Generating and Delivering” section that describes how the acute myocardial infarction (AMI) risk analysis report is generated and displayed. The discussion then includes a section, entitled “Example Processes,” that illustrates and describes example processes for implementing the described techniques. Lastly, the description includes a brief “Conclusion”.

### Example Environment

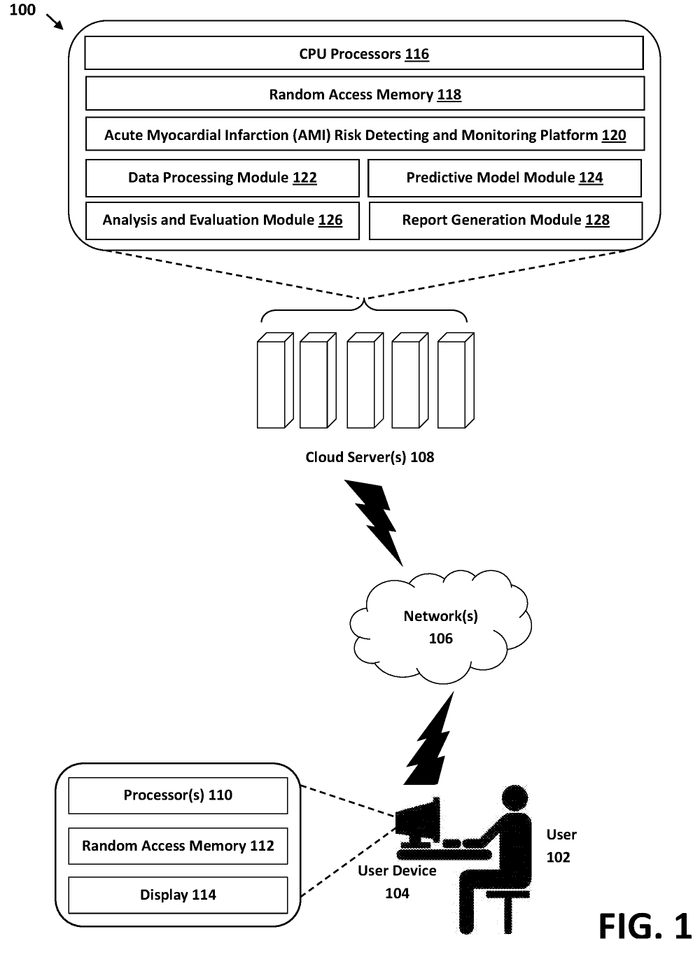

FIG. 1 illustrates a acute myocardial infarction (AMI) risk detecting and monitoring architecture 100 in which a user 102 may electronically access Acute Myocardial Infarction (AMI) Risk Detecting and Monitoring Platform (Platform) 120 and signup or login to the Platform 120 on a user device 104. As described below, the user device 104 may be implemented in any number of ways, such as a computer, a laptop computer, a tablet device, a personal digital assistant (PDA), a multi-functioning communication device, a smart TV box, a cellular phone (including smartphone), and so on. The user 102 may access the Platform 120 over a network 106, such as the Internet, which may be communicatively coupled to one or more cloud server(s) 108. The cloud server(s) 108 may store various versions of Platform 120, such as web, mobile, tablet, and other types of Platform that are accessible by the user device. For instance, the user 102 may access the Platform 120 via one or more sites (e.g., a web site) that are accessible via the network(s) 106. One or more CPU processor(s) 116 and a Random Access Memory (RAM) 118 of the cloud server(s) 108 may allow the Platform 120 to generate and display the acute myocardial infarction (AMI) risk analysis report to the user 102. More particularly, a data processing module 122, a predictive model module 124, an analysis and evaluation module 126, and an report generation module 128 are stored in RAM 118 and executed by the CPU processor(s) 116 to enable the Platform 120 to generate and display the acute myocardial infarction (AMI) risk analysis report to the user 102 based at least in part on user data.

The user 102 may access the Platform 120 in any of a number of different manners. For instance, the user 102 may access a site (e.g., a web site) associated with an entity, such as a hospital, a doctor's office or at home, that provides access to the Platform 120. Such a site may be remote from user device 104 but may allow user 102 to interact with the Platform 120 via the network(s) 106. Moreover, the user 102 may download one or more applications to the user device 104 in order to access to the Platform 120.

In some embodiments, the user device 104 may be any type of device that is capable of receiving, accessing, and/or interacting with the Platform 120, such as, for example, a personal computer, a laptop computer, a cellular telephone (including smartphone), a personal digital assistant (PDA), a tablet device, an electronic book (e-Book)) reader device, a television, or any other device that may be used to access Platform 120 by the user 102. The user device 104 shown in FIG. 1 is only one example of a user device 104 and is not intended to suggest any limitation as to the scope of use or functionality of any user device 104 utilized to perform the processes and/or procedures described herein.

The processor(s) 110 of the user device 104 may execute one or more modules and/or processes to cause the user device 104 to perform a variety of functions, as set forth above and explained in further detail in the following disclosure. In some embodiments, the processor(s) 110 may include a central processing unit (CPU), a graphics processing unit (GPU), both CPU and GPU, or other processing units or components known in the art. For instance, the processor(s) 110 may allow the user device 104 to access sites and/or download applications that are used to access the Platform 120. Additionally, each of the processor(s) 110 may possess its own local memory, which also may store program modules, program data, and/or one or more operating systems.

In at least one configuration, the Random Access Memory (RAM) 112 of the user device 104 may include any component that may be used to access the Platform 120. Depending on the exact configuration and type of the user device 104, the RAM 112 may also include volatile memory, non-volatile memory (such as ROM, flash memory, miniature hard drive, memory card, or the like) or some combination thereof.

In various embodiments, the user device 104 may also have input device(s) such as a keyboard, a mouse, a pen, a voice input device, a touch input device, etc. The user device 104 may also include the display 114 and other output device(s), such as speakers, a printer, etc. The user 102 may utilize the foregoing features to interact with the user device 104 and/or the cloud server 108 via the network(s) 106. More particularly, the display 114 of the user device 104 may include any type of display known in the art that is configured to present (e.g., display) information to the user 102. For instance, the display 114 may be a screen or user interface that allows the user 102 to access the Platform 120.

In some embodiments, the network(s) 106 may be any type of network known in the art, such as the Internet. Moreover, the user device 104 and the cloud server(s) 108 may communicatively couple to the network(s) 106 in any manner, such as by a wired or wireless connection. The network(s) 106 may also facilitate communication between the user device 104 and the cloud server(s) 108, and also may allow for the transfer of data or communications between. For instance, the cloud server(s) 108 and/or other entities may provide access to the Platform 120 that may be accessed utilizing the user device 104.

In addition, and as mentioned previously, the cloud server(s) 108 may include one or more CPU processor(s) 116 and a RAM 118, which may include the Platform 120, the data processing module 122, the predictive model module 124, the analysis and evaluation module 126, and the report generation module 128. The cloud server(s) 108 may also include additional components not listed above that perform any function associated with the cloud server(s) 108. In various embodiments, the cloud server(s) 108 may be any type of server, such as a network-accessible server, or the cloud server(s) 108 may be any entity that provides access to the Platform 120 that is stored on and/or is accessible by the cloud server(s) 108.

### Data Collection

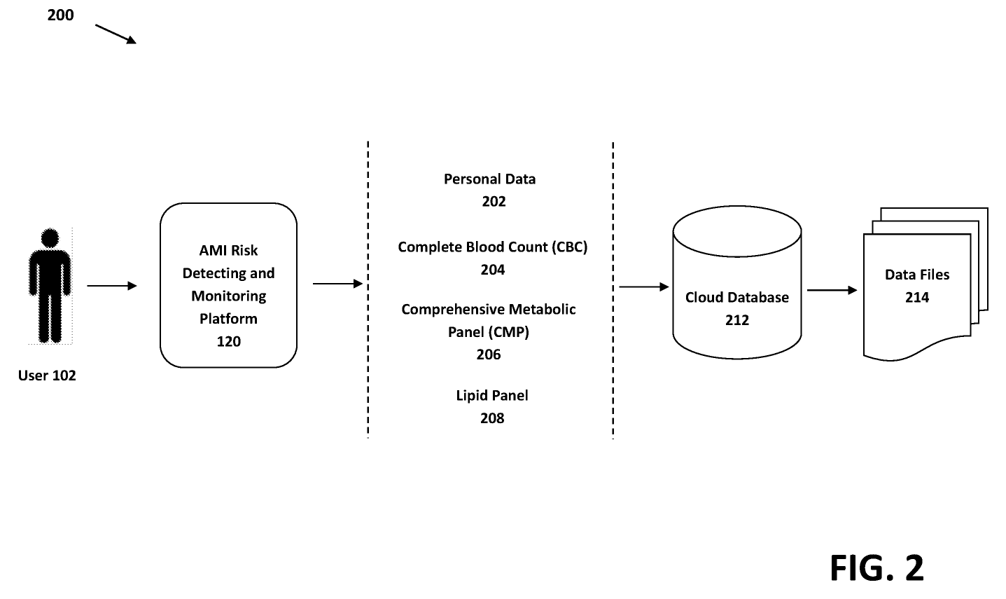

FIG. 2 illustrates a data collection process 200 in which the data being collected is provided directly from the user 102. For example, the user 102 may login to the Platform 120 to provide information about the user 102 which may include personal information 202 about the user 102, such as age, gender, height, weight, BMI and blood pressure data and the blood test results data such as CBC 204, CMP 206, and Lipid Panel data 208, etc. The collected data may be stored by the cloud database 212 inside the cloud server(s) 108, the cloud database 212 may output data files 214.

In some embodiments, the personal data 202 provided by the user 102 may include age, gender, height, weight, BMI, blood pressure or any other personal information; The CBC 204 provided by the user 102 may include White Blood Cell Count (WBC), Red Blood Cell Count (RBC), Red Cell Distribution Width (RDW), Hematocrit (HCT), Hemoglobin (HGB), Mean Corpuscular Volume (MCV), Mean Corpuscular Hemoglobin (MCH), Mean Corpuscular Hemoglobin Concentration (MCHC), Platelet (MPV), Percentage and absolute differential counts for types of WBC's including neutrophils, lymphocytes, monocytes, eosinophils, and basophils, or any other test that may be included in CBC 204; The CMP 206 provided by the user 102 may include glucose, BUN, Creatinine, BUN/Creatinine Ratio, Estimated Glomerular Filtration Rate (eGFR), Sodium, Potassium, Chloride, Carbon Dioxide, Calcium, Total Protein, Albumin, Globulin, Albumin/Globulin Ratio, Total Bilirubin, Alkaline Phosphatase (ALP), Aspartate Amino Transferase (AST), Alanine Amino Transferase (ALT), or any other test that may be included in CMP 206; The Lipid Panel 208 provided by the user 102 may include Total Cholesterol (CHOL), HDL Cholesterol, LDL Cholesterol, Cholesterol/HDL Ratio, Triglycerides (TG), or any other test that may be included in Lipid Panel 208.

In various embodiments, the cloud database 212 may be a SQL or NoSQL database management system that may provide access to a number of different databases, for example, data processing module 122. In some embodiments, the cloud database 212 may be a SQL or NoSQL database and/or a real-time database that includes multiple sources of data, such as the data processing module 122.

In other embodiments, the data files 214 generated by the cloud database 212 inside the cloud server(s) 108 may include user personal file, CBC file, CMP file, Lipid Panel file or any other file may be associated with the predictive purpose.

### Prediction

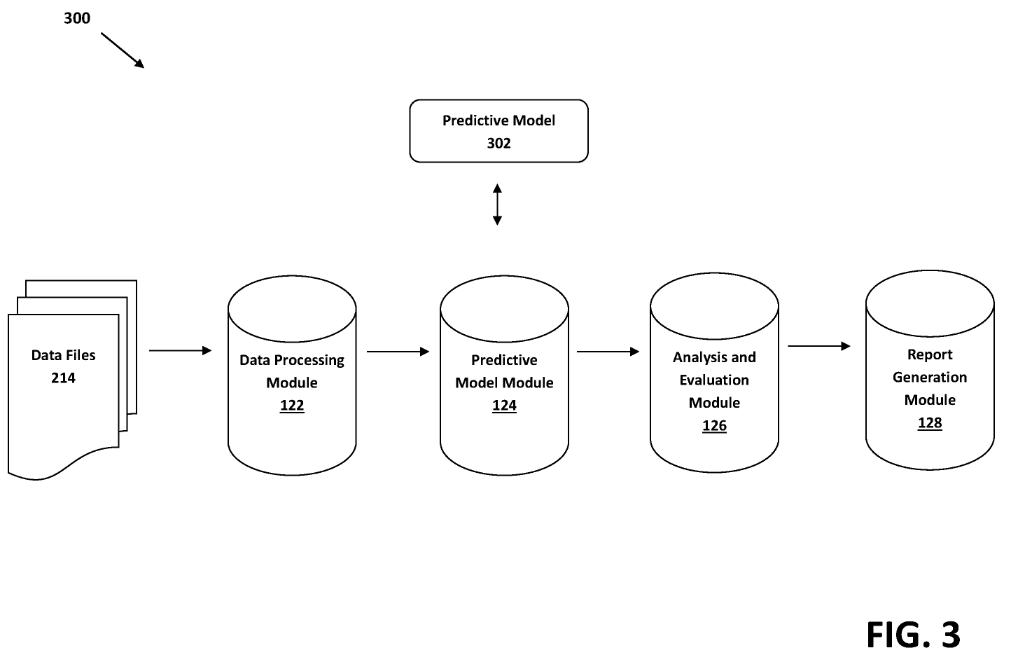

FIG. 3 illustrates a diagram showing various components and/or modules of the client server(s) 108. In some embodiments, as mentioned previously, the cloud server(s) 108 may be any type of server, a service provider, and/or a service that provides and/or facilitates user access to the Platform 120. Moreover, the cloud sever(s) 108 may include the data processing module 122, predictive model module 124, analysis and evaluation module 126, report generation module 128, and predictive model 302. As stated previously, the cloud server(s) 108 may collect user personal and blood test results data, store data, process data to output data files 214 to build predictive model 302, and/or utilize the predictive model 302 to predict and detect which user 102 is likely to have higher acute myocardial infarction (AMI) risk.

In various embodiments, the data processing module 122 may be a SQL or NoSQL database management system that may provide access to a number of different databases, for example, cloud database 212. In some embodiments, the data processing module 122 may be a SQL or NoSQL database and/or may be a production environment or a real-time database that includes multiple sources of data, such as the cloud database 212. Moreover, the data processing module 122 may store data that can be used to build a profile for each user 102. That is, each time a particular user 102 interacts with the cloud server(s) 108, such as by interacting with a site (e.g., a website) and/or an application utilizing the user device 104, the cloud server(s) 108 may store this data in the data processing module 122. Likewise, any user interaction with the Platform 120 may be represented by data that is stored in the data processing module 118.

The predictive model module 124 may calculate probabilities between the data provided by the data processing module 122 and may take the form of analytical software. Moreover, the predictive model module 12 may include or build predictive model 302 for making predictions based at least in part on the data provided by the data processing module 122. The probabilities and predictive data generated by the predictive model module 124 may be determined using one or more algorithms, which will be discussed in additional detail below. In various embodiments, the predictive model 302 may be built by the cloud server(s) 108 or the predictive model module 124. In other embodiments, the predictive model 302 may include logistic regression model, machine learning algorithms, discriminant analysis model, or any other common used statistical predictive models.

As mentioned previously, predictive model 302 and/or algorithms may be utilized by the predictive model module 124 to determine probabilities based at least in part on user 102 provided personal data 202, CBC 204, CMP 206 and Lipid Panel 208 data, or any other data may be needed by the predictive model. In some embodiments, the probabilities may be calculated utilizing Equation 1 and Equation 2, as shown below:

Logit [p(x)]=α+β1X1+β2X2+ . . . +βnXn (1)

$$p = \frac{Exp ( α + β1 X 1 + β2 X 2 + … + β nXn )}{1 + Exp ( α + β1 X 1 + β2 X 2 + … + β nXn )} \qquad ( 2 )$$

In Equation 1 and 2, p is the probability of the outcome of interest or “event”, X is the predictor variable, α is the constant of the equation, which may represent the value of p when the values of predictor variables is zero. β is the coefficient of the predictor variables, and Exp is the base of natural logarithms (approx. 2.72). In some embodiments, Equation 1 and 2 together may provide probability to acute myocardial infarction (AMI) risk corresponding to the users 102. Furthermore, β1, β2, and βn may be various weighting coefficients and X1, X2, and Xn may present personal data 202, CBA data 204, CMP data 206 or Lipid Panel data 208. In various embodiments, β1X1, β2X2, and βnXn may be utilized to determine a particular user 102 is likely to have higher acute myocardial infarction (AMI) risk.

### Analysis and Evaluation

The predictive model module 124 may generate the output for analysis and evaluation module 126, the output may include one or more tables that represent probability for acute myocardial infarction (AMI) risk.

The analysis and evaluation module 126 may utilize the net lift algorithm, the equation 3, as shown below to determine a particular user 102 is likely to have a High, Medium, or Low acute myocardial infarction (AMI) risk.

Net Lift=(Pt−Pc)/Pc (3)

where Pt is a percentage of acute myocardial infarction patients in the target/test group and Pc is a percentage of acute myocardial infarction patients in the control group.

In some embodiments, The analysis and evaluation module 126 may compare the real-time calculated probabilities by the predictive model 302 for a particular user 102 to the probabilities that are stored in the predictive model module 124 to determine the High, Medium or Low risk for the user 102. The report generation module 128 may generate acute myocardial infarction (AMI) risk analysis report based at least in part on user personal data 202 and the comparison results provided by the analysis and evaluation module 126.

### Generating and Delivering

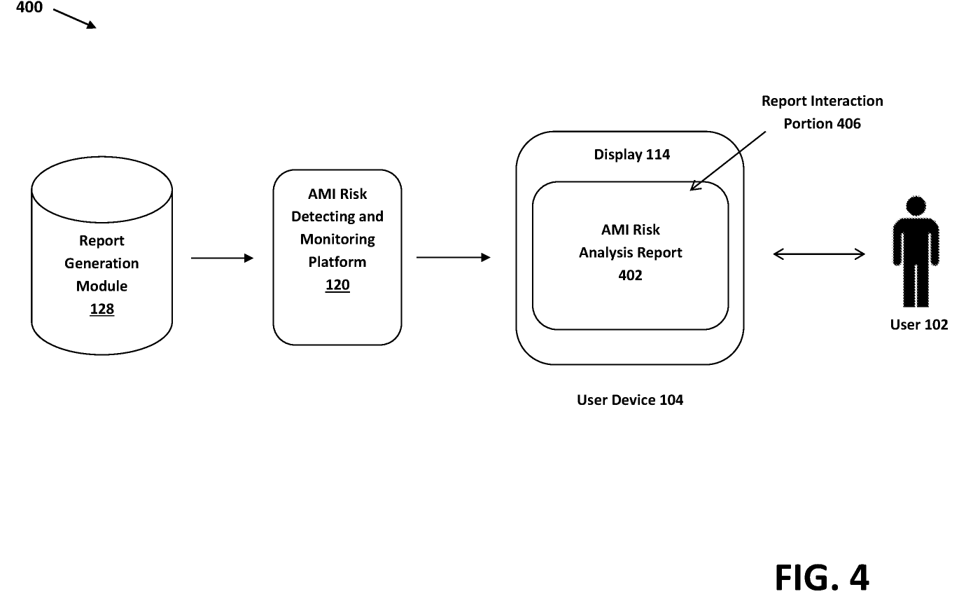

FIG. 4 illustrates a diagram representing a system 400 for generating and delivering acute myocardial infarction (AMI) risk analysis report to user 102. More particularly, the system 400 may include the report generation module 128, the acute myocardial infarction (AMI) risk detecting and monitoring platform 120, a user device 104, which may include a display 114. In some embodiments, the display 114 may include a report interaction portion 406. In various embodiments, then user 102 may access the acute myocardial infarction (AMI) risk analysis report 402 via an application that may be downloaded to and /or stored on the user device 104. In other embodiments, the user 102 may operate the user device 104 to access the acute myocardial infarction (AMI) risk analysis report 402 via a site (e.g., a website) that provided (or provides access to) the acute myocardial infarction (AMI) risk analysis report 402. For the purposes of this discussion, the term “portion” may be interchangeably referred to a “window” or a “section.”

As shown, the report generation module 128 may generate acute myocardial infarction (AMI) risk analysis report 402 based at least in part on user personal data 202 (e.g., male) and comparison results. The report generation module 128 may deliver the report to the Platform 120 and the Platform 120 may display the acute myocardial infarction (AMI) risk analysis report 402 to the user 102 via the report interaction portion 406 on user device 104.

### Example Processes

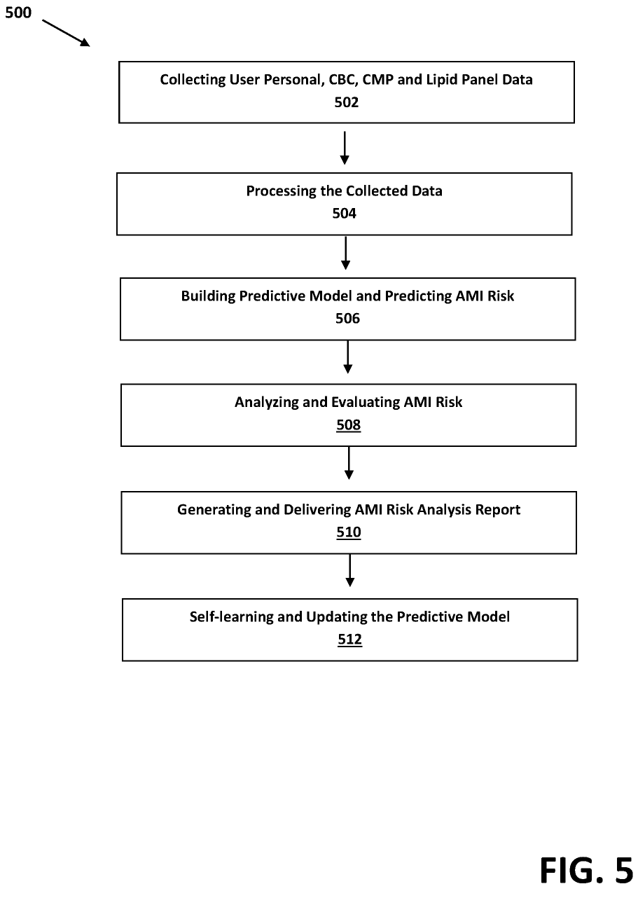

FIG. 5 describes various example processes of providing acute myocardial infarction (AMI) risk analysis report based at least in part on user provided data. The example processes are described in the context of the environment of FIGS. 1-5 but are not limited to those environments. The order in which the operations are described in each example method is not intended to be construed as a limitation, and any number of the described blocks can be combined in any order and/or in parallel to implement each method. Moreover, the blocks in FIG. 5 may be operations that can be implemented in hardware, software, or a combination thereof. In the context of software, the blocks represent computer-executable instructions stored in one or more computer-readable storage media that, when executed by one or more processors, cause one or more processors to perform the recited operations. Generally, the computer-executable instructions may include routines, programs, objects, components, data structures, and the like that cause the particular functions to be performed or particular abstract data types to be implemented.

FIG. 5 is a flow diagram illustrating an example process of providing acute myocardial infarction (AMI) risk analysis report based at least in part on user provided data. Moreover, the following actions described with respect to FIG. 5 may be performed by a server, a service provider, a merchant, and/or the cloud server(s) 108, as shown in FIGS. 1-5.

Block 502 illustrates collecting user data. In particular, the cloud server(s) 108 may collect user personal data 202, CBC data 204, CMP data 206, Lipid Panel data 208 or any other data may be associated with the predictive purpose. This data may be stored in a database or a data store for subsequent processing and/or analysis.

Block 504 illustrates processing the collected user data. The data processing module 122 may aggregate personal data 202, CBC data 204, CMP data 206, Lipid Panel data 208 or any other data at the user level and transform the data.

Block 506 illustrates building predictive model. More particularly, based at least in part on the aggregated and transformed user data 202, 204, 206 and 208, the predictive model module 124 of the cloud server(s) may build and/or maintain predictive model that may be used to determine acute myocardial infarction (AMI) risk probabilities for user 102. In other embodiments, the predictive model may utilize one or more algorithms to make such predictions.

Block 508 illustrates analyzing and evaluating the acute myocardial infarction (AMI) risk probabilities. The analysis and evaluation module 126 may compare the real-time calculated probabilities by the predictive model 302 for a particular user 102 to the probabilities that are stored in the predictive model module 124 to determine the High, Medium or Low risk for the user 102.

Block 510 illustrates generating and delivering the acute myocardial infarction (AMI) risk analysis report. In some embodiments, the report generation module 128 may generate the acute myocardial infarction (AMI) risk analysis report based at least in part on user personal data (e.g., age) and the probability comparison results. The acute myocardial infarction (AMI) risk analysis report may be delivered to user 102 via a user device 104. More particularly, the acute myocardial infarction (AMI) risk analysis report may be provided via an application associated with the user device 104, a site (e.g., website) associated with the Platform 120, messages (e.g., e-mail messages, SMS messages, instant messages, WeChat, etc.) transmitted to the users 102, and/or any other method of communicating the acute myocardial infarction (AMI) risk analysis report to users 102.

Block 512 illustrates updating the predictive model. More particularly, the predictive model may be updated based on the most current user data 202, 204, 206 and 208 provided by the users 102. For example, as user health condition changes, user weight, BMI, blood pressure and blood test results of Complete Blood Count (CBC), Comprehensive Metabolic Panel (CMP) and Lipid Panel data would change accordingly, the cloud server(s) 108 may continue to collect data indicating such changes and update the predictive model. As a result, the acute myocardial infarction (AMI) risk analysis report that may be provided to users 102 may reflect the user 102 most current acute myocardial infarction (AMI) risk.

### Conclusion

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A method comprising:
Collecting, by the cloud server device, user personal, CBC, CMP and Lipid Panel data that are provided by user who login to the acute myocardial infarction (AMI) risk monitoring platform via a network through a user device;
Predicting and detecting, by the cloud server device and based at least in part on the user provided data, probabilities of acute myocardial infarction (AMI) risk;
Analyzing and evaluating, by the cloud server device, the probabilities of acute myocardial infarction (AMI) risk; and
Generating and delivering, by the cloud server device, the acute myocardial infarction (AMI) risk analysis report; and
Monitoring, by the user through the device, the acute myocardial infarction (AMI) risk based at least in part on the analysis results.

2. The method as recited in claim 1, wherein the collecting includes user provided personal data such as age and weight, CBC, CMP and Lipid Panel data.

3. The method as recited in claim 1, further comprising building predictive model that determine the probabilities of acute myocardial infarction (AMI) risk.

4. The method as recited in claim 1, wherein the analyzing and evaluating include using the net lift algorithm to compare and rank the probabilities, and to determine acute myocardial infarction (AMI) risk.

5. The method as recited in claim 1, further comprising real-time generating acute myocardial infarction (AMI) risk analysis report based on user personal data and evaluation results and delivering the report to a particular one or more user devices.

6. The method as recited in claim 1, wherein the user can get the analysis report through via one or more user devices to review and monitor acute myocardial infarction (AMI) risk.

7. A system comprising: One or more CPU processors and RAM communicatively coupled to the one of more CPU processors for storing:
A data processing module that aggregates personal data and CBC, CMP and Lipid Panel data at user level and transforms the data; and
An analysis and evaluation module that analyzes the calculated user acute myocardial infarction (AMI) risk probabilities and compares them with the probabilities of the acute myocardial infarction patients stored in the predictive model module to determine the High, Medium or Low risk;
An acute myocardial infarction (AMI) risk detecting and monitoring platform that dynamical collects user personal and CBC, CMP and Lipid Panel data and delivers the acute myocardial infarction (AMI) risk analysis report through the user interface to help user monitor acute myocardial infarction (AMI) risk.

8. The system as recited in claim 7, wherein the data processing module includes log, fraction and/or square root transformation.

9. The system as recited in claim 7, wherein the data processing module further: Aggregates, personal, CBC, CMP and Lipid Panel data at the user level; and Transforms the aggregated data using log, fraction and/or square root.

10. The system as recited in claim 7, wherein the predictive model module includes using predictive model to determine acute myocardial infarction (AMI) risk probabilities.

11. The system as recited in claim 7, wherein the analysis and evaluation module compares the probabilities between acute myocardial infarction patients and a user and then to determine the High, Medium or Low risk.

12. The system as recited in claim 7, wherein the analysis and evaluation module includes using a net lift formula.

13. The system as recited in claim 7, wherein the real-time delivering module provides acute myocardial infarction (AMI) risk analysis report via an application associated with the particular user device, a web site associated with acute myocardial infarction (AMI) risk analysis messages transmitted to the particular user device.

14. The system as recited in claim 7, wherein the acute myocardial infarction (AMI) risk analysis report are generated and delivered in real-time.

15. One or more computer-readable media having computer-executable instruction that, when executed by one or more processors, performing operations comprising:
Collecting the personal, CBC, CMP and Lipid Panel data that are provided by a user through one or more user devices;
Building predictive model based at least in part on the user provided data.
Generating and delivering the acute myocardial infarction (AMI) risk analysis report via a network through one or more user devices.
Updating the predictive model based at least in part on user personal, CBC, CMP and Lipid Panel data.

16. The computer-readable media as recited in claim 15, wherein the one or more predictive models determine the probabilities using regression analysis or machine learning algorithms.

17. The computer-readable media as recited in claim 15, wherein the personal data includes age, gender, height, weight, BMI, blood pressure and the blood test results data includes Complete Blood Count (CBC), Comprehensive Metabolic Panel (CMP) and Lipid Panel.
